(19) United States
(12) Patent Application Publication
(10) Pub. No.: US 2017/0292813 A1
(43) Pub. Date: Oct. 12, 2017

(54) TARGET SHOOTING

(71) Applicant: JAB COMPANY LLC, Boise, ID (US)

(72) Inventor: Jarrett SPEITH, Bellingham, WA (US)

(21) Appl. No.: 15/093,676

(22) Filed: Apr. 7, 2016

(51) Int. Cl. F41G 3/26; G09B 9/00; F41A 19/09

(52) U.S. Cl. CPC F41G 3/2655; F41A 19/09; G09B 9/003

(57) ABSTRACT

A system for firearm target shooting monitoring, training, and feedback includes a camera directed at the aiming point of a firearm or a firearm training device. Embodiments include a trigger sensor and a laser emitter aimed at the aiming point of the firearm or firearm training device. A computer module can analyze video captured by the camera and determine if the firearm or firearm training device was aimed at a target region at the time of a trigger pull. User performance can be monitored, recorded, tracked, and reported to the user. Training and instruction modules can provide directed instruction and training exercises for a user to work on particular skills for which the user desires to raise proficiency.

### BACKGROUND

### Field of the Invention

The present disclosure is related to practice target shooting using electronic devices to monitor firearm proficiency of one or more users.

### Related Art

Various electronic systems are currently available to detect firearm target hit detection. Some systems use complicated target-based sensors that detect lasers emitted from a practice firearm, while other systems utilize simple laser-emitting devices that may lack the ability to provide useful recording or feedback functionality.

Currently, there are no simple, integrated, low-cost devices available that reliably track firearm performance without utilizing complicated and costly targeting systems.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a perspective view of a target shooting practice module according to one embodiment of the present disclosure;

FIG. 2 depicts a target shooting practice module attached to a pistol in accordance with embodiments of the present disclosure;

FIG. 3 depicts a target shooting practice module attached to a rifle in accordance with embodiments of the present disclosure;

FIG. 4A is a perspective view of a target shooting training firearm according to one embodiment of the present disclosure;

FIG. 4B is an isometric front view of a target shooting training firearm according to one embodiment of the present disclosure;

FIG. 5 is a block diagram of a shooting training system according to one embodiment of the present disclosure; and

FIG. 6 depicts captured target data according to various embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

The present disclosure is directed to methods and apparatus for enhancing and/or facilitating target practice shooting by allowing users to track, monitor, diagnose, and therefore improve skills related to firearms. In the following description, reference is made to the accompanying drawings that form a part hereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

According to various embodiments of the present disclosure, practice target shooting may be enhanced by utilizing a light beam or other targeting signal emitted from an aimed device and using a camera or other light-sensing device to capture and track the aiming proficiency of the user. In one embodiment, a user aims a firearm that has a laser-emitting module at a target while a camera captures the target and tracks the firearm aiming point by identifying the laser point. FIG. 1 depicts a target shooting practice module 100 according to one embodiment of the present disclosure. In the illustrated embodiment, target shooting module 100 includes a laser emitter 110, a camera 120, and an attachment rail 130. A rigid housing 140 encloses and protects internal components and maintains the aiming integrity of target shooting practice module 100.

In one embodiment, the laser emitter 110 is trained on an aiming point of a firearm or firearm training device so that the laser aims at wherever the firearm or firearm training device is aiming. In various embodiments, laser emitter 110 or an equivalent light-emitting device may act as a targeting indicator, in that the light-emitting device indicates the aiming point of the firearm or firearm training device.

Embodiments of target shooting practice module 100 include a calibration mechanism to allow for fine-tuning of the aiming point of laser emitter 110. In embodiments, calibration set screws contact a diode post of laser emitter 110 so that a user can sight-in laser emitter 110 by selectively turning the calibration set screws.

In embodiments, camera 120 remains trained on a target area. In the embodiment depicted in FIG. 1, camera 120 is within housing 140 of target shooting practice module 100 and thus is directed at the aiming point of laser emitter 110. In other embodiments, a camera is external to housing 140. For example, a camera may be placed on a stand to be directed to a target where the laser emitter 110 is aiming. In one embodiment where situations call for multiple targets, multiple cameras each point at one or more targets and each camera captures some of the total number of targets. In such situations, data from the various targets may be subsequently aggregated for analysis.

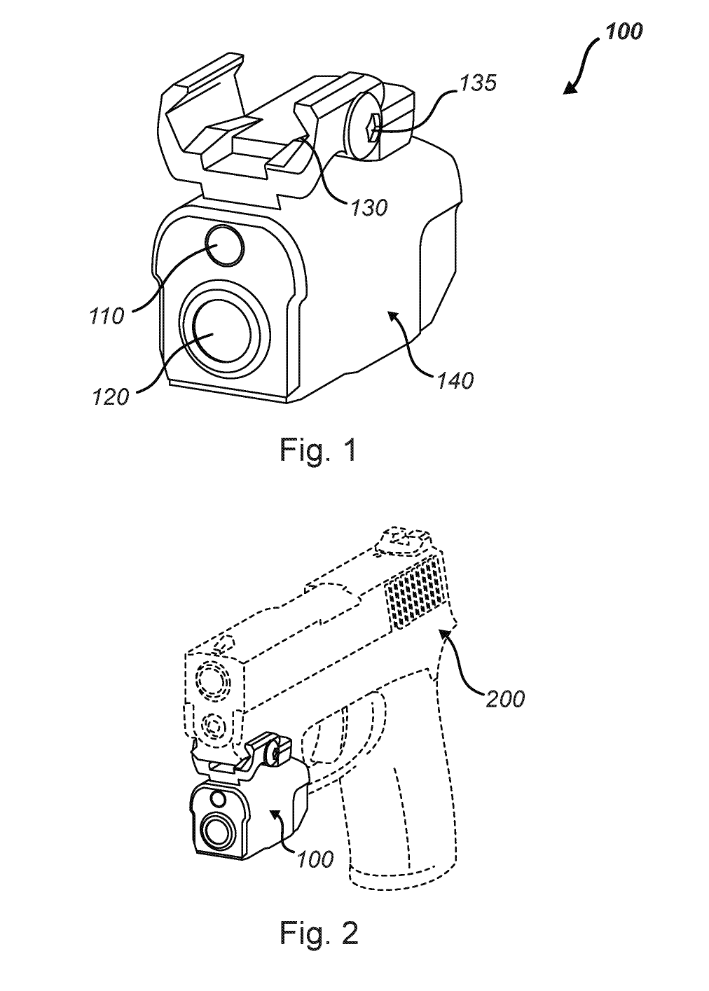

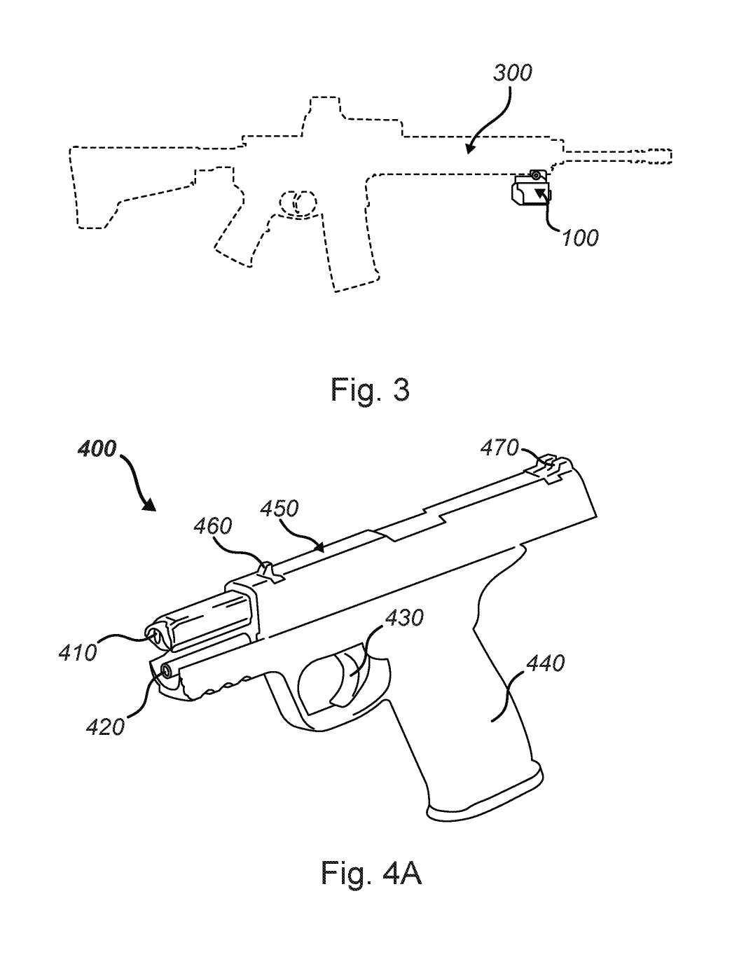

In various embodiments of the present disclosure, attachment rail 130 is configured to mount target shooting practice module 100 to a firearm. Embodiments of attachment rail 130 fit standardized firearm mounting brackets or other types of mounting platforms. For example, embodiments of attachment rail 130 are compatible with rail interface systems including a Weaver rail mount, a Picatinny rail, a NATO Accessory Rail, and/or other rail accessory systems. Rail screw 135 can be tightened to secure target shooting practice module 100 to the firearm rail. In other embodiments, attachment rail 130 is configured to mount target shooting practice module 100 to various types of firearm training devices. FIG. 2 depicts target shooting practice module 100 attached to a pistol 200. FIG. 3 depicts target shooting practice module 100 attached to a rifle 300.

In alternative embodiments, target shooting practice module 100 can be worn on the body of a shooter or observer. For example, target shooting practice module 100 may be attached to goggles, hats, or other clothing and/or accessories in a way that allows it to align with the intended direction of fire and/or line of sight toward a target or other object.

In one embodiment, target shooting practice module 100 comprises an internal trigger sensor. The trigger sensor is configured to detect when the trigger of the attached firearm has been pulled. The trigger sensor can include a mechanical switch, a microphone, an accelerometer, and/or additional components configured to detect a trigger pull. In one embodiment, an optical component such as a camera can visually detect a trigger pull. In embodiments, various combinations of the foregoing mechanisms and/or methods for determining if a trigger has been pulled may be utilized.

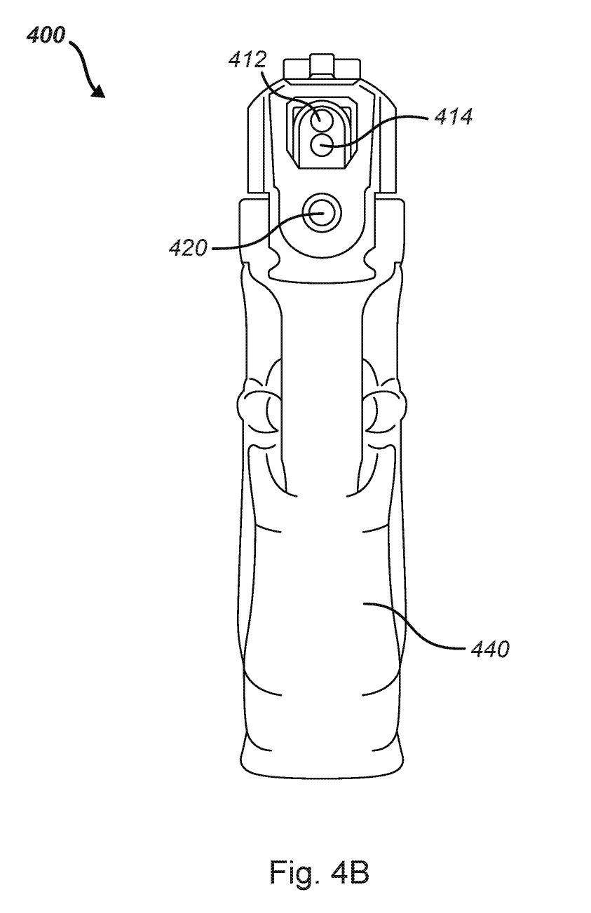

Referring now to FIGS. 4A and 4B, a target shooting training firearm 400 is depicted. According to one embodiment of the present disclosure, target shooting training firearm 400 comprises a camera module 410, a laser module 420, and a trigger module 430. In one embodiment, target shooting training firearm 400 has the form of a pistol, including a grip 440, a barrel 450, and sights 460, 470. In other embodiments, a target shooting training firearm is in the form of a rifle or in the form of other firearm platforms.

In one embodiment, camera module 410 comprises a primary camera 412 and a secondary camera 414. Primary camera 412 and secondary camera 414 are aimed at the aiming point of target shooting training firearm 400 so that when activated, they can capture its target. Laser module 420 comprises a laser emitter that is also directed at the aiming point of target shooting training firearm 400 so that when a camera 412 or 414 and laser module 420 are activated, camera 412 or 414 can capture an image of the laser point and therefore the aiming point of target shooting training firearm 400.

Trigger module 430 comprises an internal trigger sensor. The trigger sensor is configured to detect when the trigger has been pulled. In an embodiment, the trigger sensor can transmit a signal to an analysis module to indicate that the trigger was pulled. In various embodiments, the trigger is spring-loaded so that it returns to its original position when released.

In various embodiments of target shooting practice module 100 or target shooting training firearm 400, the apparatus comprises one or more microprocessors and internal circuitry to receive captured video from camera 110 and transmit the video to a processor for further analysis. In one embodiment, a computer processor within target shooting practice module 100 is configured to conduct analysis of the video to track and analyze the aiming point and provide feedback to the user. In some embodiments, target shooting practice module 100 and/or target shooting training firearm 400 includes additional sensors such as an accelerometer, a Global Positioning System (“GPS”) module, a compass, a gyroscope, and other similar sensors or systems configured to detect movement, vibration, and/or orientation of target shooting practice module 100 or target shooting training firearm 400.

According to embodiments of the present disclosure, a computer processor is programmed to analyze video captured by one or more cameras to assess a user's firearm proficiency. In one embodiment, video is captured by a camera directed at a target. In embodiments, the camera and/or video analysis processor is configured to recognize and track a laser point having the particular pulse length, duration, and/or frequency of the laser module and/or laser emitter. The video or images captured can depict the target that corresponds to the aiming point of the firearm or firearm training device. In one embodiment, data can be gathered continuously as the user aims the firearm or firearm training device.

Embodiments of the present disclosure include a communications module configured to transmit data signals to an external and/or remote computing device for processing the data and/or uploading the data to a remote sever. The communications module can transmit data or otherwise connect to the external and/or remote computing device. In one embodiment, the external and/or remote computing device comprises a nearby personal computer or another type of consumer computing device. In another embodiment, the external and/or remote computing device comprises one or more servers that are configured to aggregate and/or analyze the uploaded data as will be explained in further detail. In various embodiments, the communications module utilizes a wireless communication protocol or network such as Bluetooth, Wi-Fi, or a cellular network. In one embodiment, data is transmitted through the Internet or other wide area network.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments of target shooting practice module 100 and target shooting training firearm 400 include a power source within the module. In embodiments, the power source comprises a rechargeable battery cell. In other embodiments, the power source comprises one or more replaceable disposable battery cells.

The flowcharts and block diagram in the attached figures illustrate the architecture, functionality, and operation of possible implementations of systems, methods, and computer program products according to various embodiments of the present disclosure. In this regard, each block in the flowcharts or block diagram may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagram block or blocks.

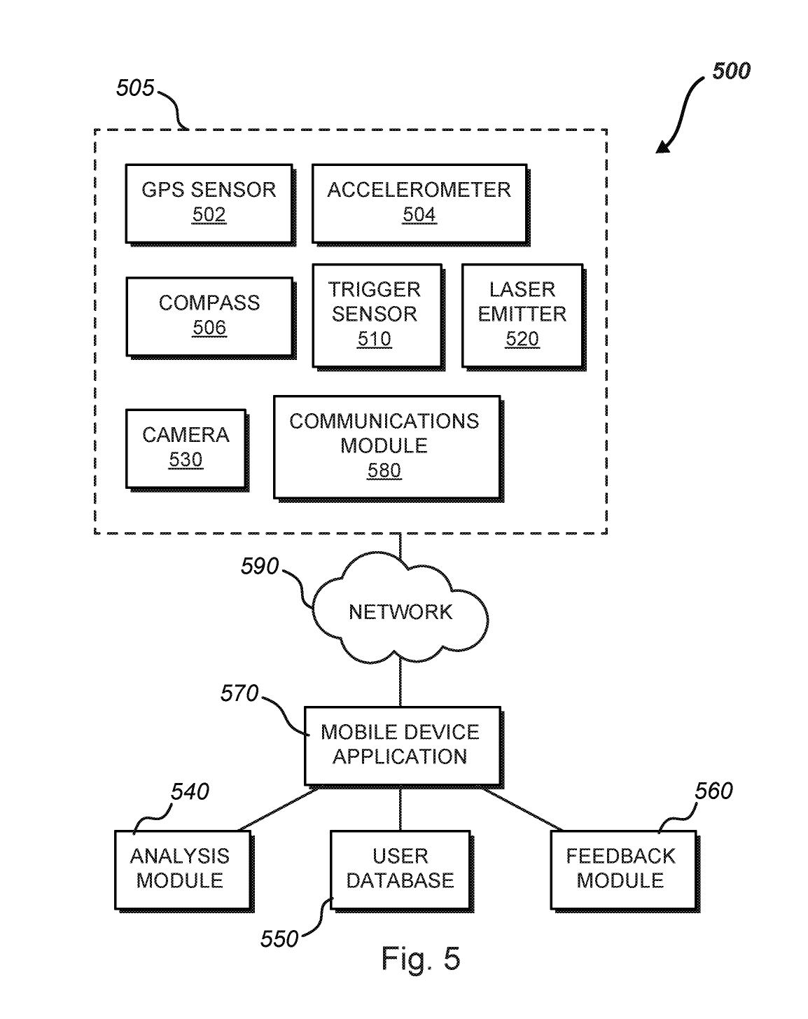

Referring to FIG. 5, a block diagram of one embodiment of a shooting training system 500 is depicted. According to one embodiment, a firearm training device 505 is equipped with a trigger sensor 510, a laser emitter 520, and a camera 530. In other embodiments, laser emitter 520 and camera 530 are separate modules that are each aimed at a target area. Trigger sensor 510 is configured to detect a trigger pull. In one embodiment, trigger sensor 510 can transmit a trigger signal to laser emitter 520, which is configured to emit a laser in response to the trigger pull. In one embodiment, trigger sensor 510 can transmit a trigger signal to camera 530, which is configured to capture an image and/or video of the target area in response to the trigger pull.

In another embodiment, laser emitter 520 and/or camera 530 continuously operate to emit the laser and capture an image and/or video, respectively. In this embodiment, trigger sensor 510 is configured to transmit a trigger timestamp to analysis module 540. In this embodiment, the trigger timestamp can indicate the time at which the user pulled the trigger. Analysis module 540 can match the trigger timestamp to video timestamps and/or laser emission timestamps to determine the aiming point at the time of the trigger pull and thereby analyze the user's performance.

Various embodiments of shooting training system 500 comprise GPS sensor 502, accelerometer 504, compass 506, and other types of sensors to detect movement, position, and orientation of a firearm or firearm training device.

Analysis module 540 is adapted to receive and interpret data related to the shooting performance of one or more users, including the users' aiming proficiency. Said data may include data generated and/or captured by GPS sensor 502, accelerometer 504, compass 506, trigger sensor 510, camera 530, and additional sensors or data collection components configured to monitor a user's actions during target shooting.

Analysis module 540 can store the user's performance data and/or analysis results at user database 550. In embodiments, user database 550 comprises a remote data store accessible over the Internet or other network. User performance data over time may be stored at user database 550 to monitor trends, identify shooting improvement, and create reports to present to each user. In embodiments, shooting training system 500 comprises feedback module 560. Embodiments of feedback module 560 are programmed to analyze user performance data and present reports to a user regarding various aspects of the user's shooting proficiency. Feedback module 560 is adapted to transmit user scores, reports, and other types of feedback to each user. In embodiments, users may view such feedback via a mobile device application (“app”) 570 installed on a smartphone or like device.

In one embodiment, communications module 580 enables communication amongst trigger sensor 510, laser emitter 520, camera 530, analysis module 540, user database 550, feedback module 560, and app 570. In embodiments, communications module 580 facilitates communication via wireless communication protocols such as Wi-Fi, Bluetooth, a cellular network, or the like. In one embodiment, communication between trigger sensor 510, laser emitter 520, camera 530, and communication module 580 may be carried out via such wireless communication methods. In one embodiment, communication between communications module 580, analysis module 540, feedback module 560, and/or app 570 may be carried out over network 590. In embodiments, network 590 comprises various forms including, but not limited to, a wireless network, a cellular network, an intranet, the Internet, or combinations thereof.

In operation, when a trigger pull is detected, a trigger signal is transmitted to the laser module and/or laser emitter. In embodiments, the trigger signal can direct the laser emitter to emit a laser at a specific pulse length, duration, and/or frequency to indicate that a simulated shot has been fired by the user. In other embodiments, the laser module and/or laser emitter continuously emits a laser while the unit is powered so that the user's aim can be captured before and after firing each shot. Embodiments include software aiming calibration to identify if the laser emitter is not aligned with the firearm and/or firearm training device. If the laser emitter is not aligned, the analysis module software can compensate and adjust for the aiming misalignment.

In embodiments, the user app can be accessed on a mobile device, laptop, desktop computer, tablet device, or other computer device. In one embodiment, the user computing device can wirelessly synchronize to the camera module and/or laser module on or near the firearm and/or firearm training device to receive video and/or other data from the camera and other sensors.

While accessing the user app for a first time, the user can enter an initial setup mode wherein the user can enter specific training goals and/or levels of difficulty and/or types of firearm platforms for which the user intends to train. In embodiments, the user can take an initial assessment test by participating in a target shooting session with the firearm and/or firearm training device. The target shooting session can then be analyzed by the analysis module to determine areas of improvement for the user. Once the initial setup mode is complete, the app and/or analysis module can report initial settings and/or results of the initial assessment test to the user database. In response to the initial settings and/or results of the initial assessment test, the analysis module can formulate a specific set of drills, instructional videos, and/or similar content to be transmitted to the user mobile device to begin subsequent user training.

In normal operation, the camera and other various sensors installed on the firearm or firearm training device can detect events and/or generate data such as accelerometer data, timing, position, and laser activation against the target, hits or misses on a target, raw video, and other data generated as the user aims and fires at a target. Captured data may be buffered and streamed to the mobile app or user computing device via wireless signal such as Wi-Fi or Bluetooth. In one embodiment, the captured video is streamed to the mobile app or user computing device. In another embodiment, the captured data and/or video are transmitted to the analysis module. The captured data may be combined with any additional data obtained from the mobile device and app such as position and acceleration of the mobile device itself in relation to the firearm or firearm training device and/or the camera module and/or the laser module. Performance results from individual or cumulative training sessions may be generated on the display of the user's computing device. In one embodiment, the user may input selections on the computing device through the app, which may transmit commands to control and/or interface with the camera module and/or laser module.

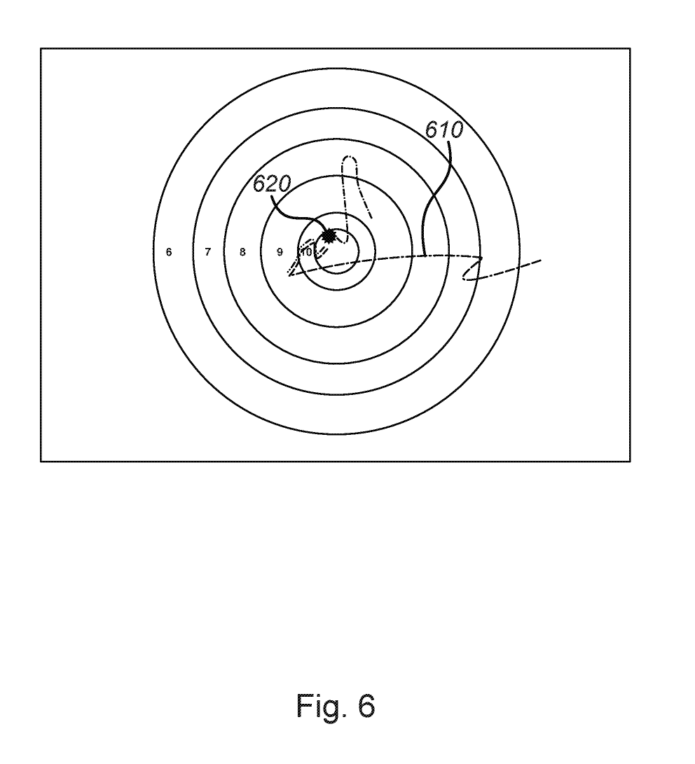

Referring to FIG. 6, an example of captured target data is depicted. In the embodiment depicted, captured data represents a user's aiming point over time 610 and a trigger pull 620. In embodiments, the analysis module may analyze the user's aiming and/or shooting behavior by interpreting the magnitude of displacement of the laser and/or distance to the target combined with data from accelerometers, a gyroscope, and other sensors to determine the orientation, attitude, position, and/or speed of the user relative to the target to interpolate if a shot would be a hit or miss. In embodiments, the analysis module employs vector mathematics to assign a magnitude of velocity and direction of the movement of the laser point and relation of the movement of the target and the camera module and/or laser module to determine if the resultant aiming point would be inside or outside the boundary of a designated target region.

The user database can store a profile for each user based on the performance measurements received from training sessions. In an embodiment, the analysis module is programmed to compare the results of a training session to the user's goals and/or established metrics. As selected goals are met by a user, feedback module can provide virtual achievements, badges, and rewards to the user. Additionally, as a user meets certain goals and/or challenges, more difficult challenges may be made available to the user.

Embodiments of analysis module are configured to compare each user's performance data from cumulative training activities and/or from recent training sessions with that of the user's goals. Particular training drills and/or instruction modules may be selected from an installed library of drills and instruction modules to provide an adaptive progression of difficulty to stimulate performance growth. In one embodiment, users can choose to share their accomplishments and/or goals with other users. In one embodiment, users may select to maintain their usage information private.

Embodiments of the present disclosure include multiple modes of operation. In one embodiment, modes of operation include a coaching mode, an instructional mode, a scenario-based training mode, and a live fire mode. In various embodiments, the user can select the mode of operation from a menu and then begin training and/or practicing in that mode.

In one embodiment, coaching mode allows the user to follow specific video and/or audible instructions displayed on the computing device display and/or played through device speakers. The user can download and install selected training instruction and video modules to add to a library of saved drills and training courses. In one embodiment, a user may create and upload drills and/or training courses to share with an online community. In one embodiment, the user can select any training course or allow the analysis module to select an appropriate training course based on the user's skill level and/or past performance.

In one embodiment, instructional mode allows the user to stream data and raw video that was captured during a shooting session to a computing device. In real-time or near real-time, the video and performance measurements can be displayed. An instructor can monitor the user's performance by viewing the video. In embodiments, the instructor can remotely observe the user. Instructional mode may allow an instructor to monitor the user to provide a human perspective to the results and performance measurements captured.

In one embodiment, scenario-based training mode allows the user to participate in a training simulation alone or with other users. In scenario-based training mode, the analysis module is configured to identify human-shaped objects as targets. In embodiments, the analysis module can distinguish between laser emissions from multiple users in the same environment because the laser emitter used by each user has a distinct pulse length, duration, and/or frequency. Accordingly, multiple users can each have their actions recorded and analyzed.

In one embodiment, live fire mode allows the user to live fire a firearm while still recording the user's performance. The analysis module can be initially calibrated by the user for the specific pulse and/or energy characteristics of the user's live firearm. The target shooting practice module attached to the firearm can use its internal sensors to measure and record the energy output when a shot is fired. This calibration data can be recorded at the user database so its sensors can identify when the firearm fires and, in response, activate its laser to lase the target. The camera module may capture the target and other sensors can capture data relating to the user's performance. Data collection and analysis may be similar to that of the other modes of operation. In embodiments, the same reward and user interface can be utilized for live fire mode as for the other modes described above. In embodiments, the user can share and compare firearm training results with other members of an online community.

According to one embodiment, the user may train with selected specific targets by pointing the camera device at a desired target and selecting the object as a target object on the display of the user computing device. In other embodiments, targets are recognized from a built-in library and database of targets. For example, image recognition techniques can be utilized to recognize a human torso target as a target region for the purposes of tracking target hits.

Embodiments of the present disclosure can incorporate social features to encourage user participation and incentivize improvement. For example, particular challenges can be issued to users. Challenges may include daily challenges and/or skill challenges. Additional social features may include leader boards showing each user's rank, challenge completion time, and user name. In one embodiment, video instructions are provided via the user interface on the user computing device. Such videos can include demonstrations for training, challenges, and the like.

According to some embodiments, the feedback module can display analytics relating to the user's performance for various drills, challenges, and/or other activities. The analytics can include technique and/or accuracy of the user. In embodiments, a summary of data relating to a user's shooting proficiency can be presented to the user. In one embodiment, the user can select to share the data summary with an online community of users. In one embodiment, a positive rewards system can be implemented that includes tracking and sharing goals, accomplishments, and rewards in the style of a social network or similar online community to incentivize users to practice and improve.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the disclosure.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed:

1. An system for target practice, comprising:
a firearm device;
a laser emitter directed at an aiming point of the firearm;
a camera directed at the aiming point of the firearm; and
an analysis module configured to:
receive a video captured by the camera;
receive a trigger signal indicating a trigger pull event; and
evaluate if the laser emitter lased a target region in the video at the trigger pull event.

2. The apparatus of claim 1, wherein the firearm device comprises a target shooting training firearm.

3. The apparatus of claim 1, wherein the firearm device comprises a firearm.

4. The apparatus of claim 1, wherein the laser emitter and the camera are secured in a housing of a target shooting practice module.

5. The apparatus of claim 4, wherein the housing of the target shooting practice module is attached to a firearm.

6. The apparatus of claim 1, wherein the laser emitter is attached to the firearm device.

7. The apparatus of claim 1, wherein the camera is attached to the firearm device.

8. The apparatus of claim 1, further comprising a feedback module configured to report to a user if the laser emitter lased the target region in the video at the trigger pull event.

9. A method for target practice comprising:
receiving an image generated by a camera directed at an aiming point of a firearm device;
identifying the aiming point in the image;
identifying a target region in the image;
identifying a trigger pull time;
determining if the aiming point was within the target region at the trigger pull time.

10. The method of claim 9, wherein the firearm device comprises a target shooting training firearm.

11. The method of claim 9, wherein the firearm device comprises a firearm.

12. The method of claim 9, wherein the aiming point in the image comprises a laser point.

13. The method of claim 9, wherein the camera is in a housing of a target shooting practice module.

14. The method of claim 13, wherein the housing of the target shooting practice module is attached to a firearm.

15. The method of claim 9, further comprising providing feedback to a user, the feedback including information relating whether the aiming point was within the target region at the trigger pull time.

16. The method of claim 9, further comprising emitting a laser at the aiming point of a firearm device.
